(19) United States
(12) Patent Application Publication
(10) Pub. No.: US 2008/0208643 A1
(43) Pub. Date: Aug. 28, 2008

(54) Follow your stars

(75) Inventors: Guglielmo Guastalla, Antibes (FR); Richard Savornin, Valbonne (FR)

Correspondence Address: YOUNG & THOMPSON, 209 Madison Street, Suite 500, ALEXANDRIA, VA, 22314, US

(73) Assignee: AMADEUS S.A.S, BIOT (FR)

(21) Appl. No.: 11/709,222

(22) Filed: Feb. 22, 2007

(51) Int. Cl. G01C 21/36

(52) U.S. Cl. 705/6

(57) ABSTRACT

A system and methods for providing comprehensive travel package to attend an event out of a series of scheduled events are disclosed. The system comprises a server engine having means for gathering all sorts of online travel related information from a plurality of specialized websites. It includes means for storing the gathered travel information. A travel time durations and costs calculator operates from the gathered travel information in order to dynamically build the comprehensive travel packages. Sets of comprehensive travel packages are then delivered to a plurality of client websites in response to the submission by their end-users of queries to attend events out of series of scheduled events. End-user queries include home locations along with further preferences that are used to dynamically build the corresponding set of comprehensive travel packages. The most appropriate event date and location is thus selected allowing to deliver the best travel package for the specified end-user home location. Preferences include minimizing overall trip elapsed times, minimizing overall trip costs and excluding some transportation means. The invention also applies to the organization of professional meetings and for socializing websites to restrict selection of people to meet only to those fitting in a cost or time metric.

The invention allows delivering, to end-users of websites proposing series of events or organizing meetings, the best comprehensive, i.e., home to home, travel packages for each one of the proposed events or meetings so that they are aware of all opportunities and travel consequences (overall durations and costs, overnight stays etc.) before they book a trip.

### FIELD OF THE INVENTION

The present invention relates generally to the field of travel reservation in view of attending or participating to a scheduled event to be chosen from a list of potential locations and dates. It more particularly relates to the planning of the overall travel arrangements to put in place in order to achieve a particular objective; e.g., choosing event (date plus location) that minimizes the elapsed time to be attended from a home location or event that minimizes the total travel expenses: flight tickets, hotel room bookings, car rental fees, etc.

### BACKGROUND OF THE INVENTION

Scheduled events considered by the invention can be of many kinds. They include, but are not limited to, all sorts of publicly advertised shows; sport events; e.g., football, soccer or basketball games, concerts; e.g., pop star or opera singer tours and so on. The invention addresses as well the problem of having to meet people in one of various places where they have to show up or the problem of meeting an individual in the most convenient place while he/she traveling, such as a speaker delivering a series of conferences. Hence, a scheduled event in the context of the invention is, e.g., a particular game or show planned to occur in a given place at a defined date and time. It can be as well the fact of meeting people at one of any places where they are due to be on certain dates.

Many websites have been put together by various service providers to sell tickets on-line so that, for example, a football fan or a music lover can conveniently buy tickets for an event of his/her choice. The user interface of such websites, most often accessed through the use of any of the available web browsers or navigators running on end-user personal computer, is typically made of windows as shown in FIG. 1. The end-user can thus select a particular category of events he/she would like to attend (100). Then, as many as necessary further windows (110) are displayed by the site in response to the selections performed by the end-user until this latter is eventually prompted to buy tickets corresponding to his/her choice (120). After payment is done, generally on-line with a credit card, or through a third-party company specialized in on-line payments like “PayPal” with headquarters in San Jose, Calif., tickets are mailed. Sometimes, hard tickets are not even produced in which case the end-user of the site is just given a reference to an electronic ticket or e-ticket corresponding to the transaction to be authorized, producing some form of identification, to attend the corresponding event on the particular day and time selected,

The above process which is typical of all modern websites selling services to their remote customers is however only the easy part of what is to be done to attend or participate to an event. For example, the football fan who wants to attend a game where his/her favorite team is playing has not only to decide which date, time and location are best but must also organize his/her trip to go there. In which case many specialized popular travel sites like Opodo, Expedia, Travelocity and, possibly, travel service oriented sites to book a hotel room or rent a car have to be consulted too. This can be a time-consuming and frustrating experience especially if event takes place during peak period or at the occasion of a special event that attracts a lot of people in a same area.

Even worse, if things turn really bad, the football fan mentioned above may end up to have bought a ticket to see his/her favorite team and discover soon after that it is impossible to find a hotel room and/or a flight seat cannot be booked at a reasonable cost for attending the game, if any is left available though.

Also, the websites of the art always require that a specific event; i.e., an event scheduled on a certain date at a specified place, be selected to go further in the process of making a choice. However, very often, the football fan of the above example may just be interested in seeing his/her favorite team playing and would be as well happy to attend any of the games to which team is an opponent. When this is the case other constraints are becoming much more important to select an event. For example, a particular individual may want to minimize the overall time he/she has to spend to be able to attend an event rather than having to have to choose a particular event location and date. All occurrences of event dates, times and locations have then better to be considered in the choice to be performed. In the example of FIG. 1 end-user of the site is asked to choose between two locations and dates (130) without knowing in advance how more convenient it would be for him/her to be in Jacksonville Fla., on a Monday night or in Nashville, Tenn. on a Sunday afternoon. This is obviously highly dependent on parameters like: where individual lives; flight schedules between closest home place airport and the two above towns; if there is actually available seats on airplanes; if any of the event location can be reached by train, by car and so on including to decide if an hotel room must be booked etc.

In the light of the above discussion there thus exists a need for a website server capable of thoroughly processing requests of end-users to attend any one of a series of events while considering, optionally, only some (the main contributors) or all (including, e.g., ground transportation on short distances) of the travel constraints they are faced with for each of the events.

It is a specific object of the invention to propose a set of comprehensive travel packages in order to attend any of a series of events taking into consideration home locations and, optionally, other travel preferences specified by the end-users.

It is also an object of the invention to permit that selection of a category of events be proposed to the end-users of website on the basis of a set of away locations and dates i.e., without requiring that end-users have first to select a particular event location and date thus allowing to consider all travel opportunities for the selected category of events.

It is another object of the invention that the proposed travel packages minimize a parameter according to end-user choices such as the total travel expenses or the overall elapsed times from home to home.

Further objects, features and advantages of the present invention will become apparent to the ones skilled in the art upon examination of the following description in reference to the accompanying drawings. It is intended that any additional advantages be incorporated herein.

### SUMMARY OF THE INVENTION

The invention allows providing comprehensive travel package to attend an event out of a series of scheduled events. The system comprises a server engine having means for gathering all sorts of online travel related information from a plurality of specialized websites. It includes means for storing the gathered travel information. A travel time durations and costs calculator operates from the gathered travel information in order to dynamically build the comprehensive travel packages. Sets of comprehensive travel packages are then delivered to a plurality of client websites in response to the submission by their end-users of queries to attend events out of series of scheduled events. End-user queries include home locations along with further preferences that are used to dynamically build the corresponding set of comprehensive travel packages. The most appropriate event date and location is thus selected allowing to deliver the best travel package for the specified end-user home location. Preferences include minimizing overall trip elapsed times, minimizing overall trip costs and excluding some transportation means. The invention also applies to the organization of professional meetings and for socializing websites to restrict selection of people to meet only to those fitting in a cost or time metric.

### BRIEF DESCRIPTION OF THE DRAWINGS

FIG. 1 shows a typical user interface of a service website of the prior art.

FIG. 2 illustrates a website according to the invention allowing to propose a set of comprehensive travel packages to attend any of a series of selected events, on the basis of a home location and other preferences.

FIG. 3 illustrates, through an example, what is returned to the end-user of a website making use of the server engine of the invention in response to a query for attending any of a series of events.

FIG. 4 shows a website server engine according to the invention in its environment.

FIG. 5 shows the steps of the method of the invention more particularly adapted to event sites such as sport sites or alike.

FIG. 6 more specifically focuses on the case of professional applications such as the ones to manage meetings with people in various locations.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention.

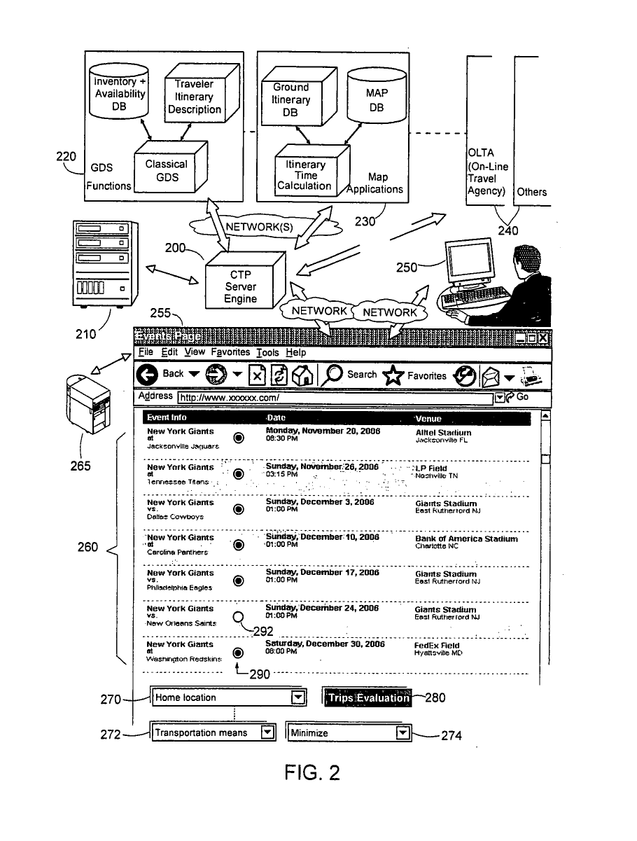

FIG. 2 illustrates a website connected to a web server engine (200) according to the invention possibly running on any computer system ranging from a stand-alone computer (210) to a large computer center hosting, e.g., all the applications and databases of a travel service provider.

The web server engine (200) in cooperation with a client web application (255), generally running from its own computer resources (265), is made capable of providing comprehensive travel packages (CTP) in response to queries issued by an end-user (250) of a web application (255).

To this end, the web server or CTP provider (200) is assumed to have access, through a network or a combination of private and public networks like the Internet, to a global distribution system or GDS (220). GDS's are large computer systems put in place by a few companies of the travel industry such as AMADEUS having corporate headquarters in Madrid, Spain. GDS's allow real-time access to airline fares, schedules, and seat availability offering the capability of booking reservations and generating tickets from all over the world. Traditional GDS's, that used to focus mainly on air travel, have widened the scope of travel services they are offering to all other forms of non-air travel ticketing and reservation services including e.g., hotel and rental car booking. Travel services further includes the possibility of calculating overall travel fares from any imbedded or stand-alone dedicated software applications.

The web server is also assumed to have access to any of the specialized on-line sites aimed at providing maps and driving directions (230), e.g., such sites like ViaMichelin or Rand McNally respectively at http://www.viamichelin.com and http://www.randmcnally.com, so that ground itineraries can be established and driving distances and driving times estimated. Moreover, applications allowing to book non transportation related items like hotel rooms need to be accessible by a web server according to the invention.

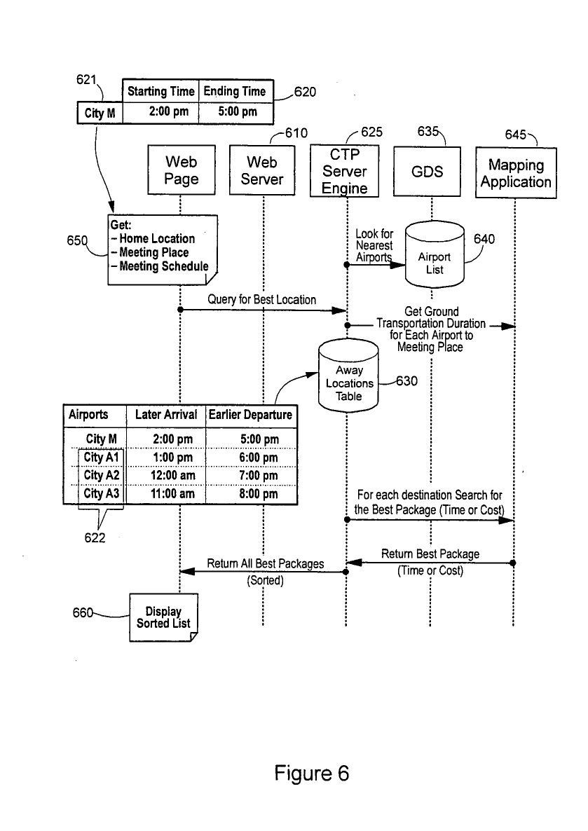

Other specialized sites, including on-line travel agencies (OLTA), may optionally have to be consulted too (240). For example, the web server engine (200) could also have to take into consideration the forecasted weather or the estimated driving conditions for the date and time when ground transportation is preferred (e.g., because distance is short or ground transportation is less expensive) or mandatory (because there is no other means of transportation). Since a website server engine according to the invention (200) is devised to consider the overall travel time necessary to attend a particular event (from home to home), all the pieces of a trip itinerary have to be considered. Thus, most often, ground transportation will have to occur at least on a portion of the itinerary e.g., from home to an airport with a taxi, a shuttle bus, etc. The time to reach the airport may be significantly different depending on the time of the day, the day of the week; hence, the consultation of specialized websites (240) such as the ones that monitor road traffic to estimate actual travel times. Optionally, this information can be conveniently provided by the client web application (255) under the form of input tables as further described in FIG. 6.

In the general case, all sorts of specialized sites may possibly have to be consulted by the website server engine to better organize a trip. Although GDS's also provide the possibility of, for example, booking hotel rooms and renting cars on top of just delivering airline tickets; all large hotel chains and rental car and train companies have their own sites that might have to be interrogated too. The sites to be consulted may also include sites as diverse as the ones providing ferry schedules between pieces of land separated by water or the ones giving the access restrictions to passes of mountain roads or to ski resorts.

Having thus access to all sorts of means to estimate, organize and book trips a server engine according to the invention (200) is armed to process the requests received from client applications of service providers such as the ones discussed in the background section i.e., the ones providing tickets to attend shows, concerts and events of all sorts, so that end-users of such websites can be proposed a comprehensive list of locations for the scheduled events they are interested to attend without having to first select a particular event i.e., a date and a location.

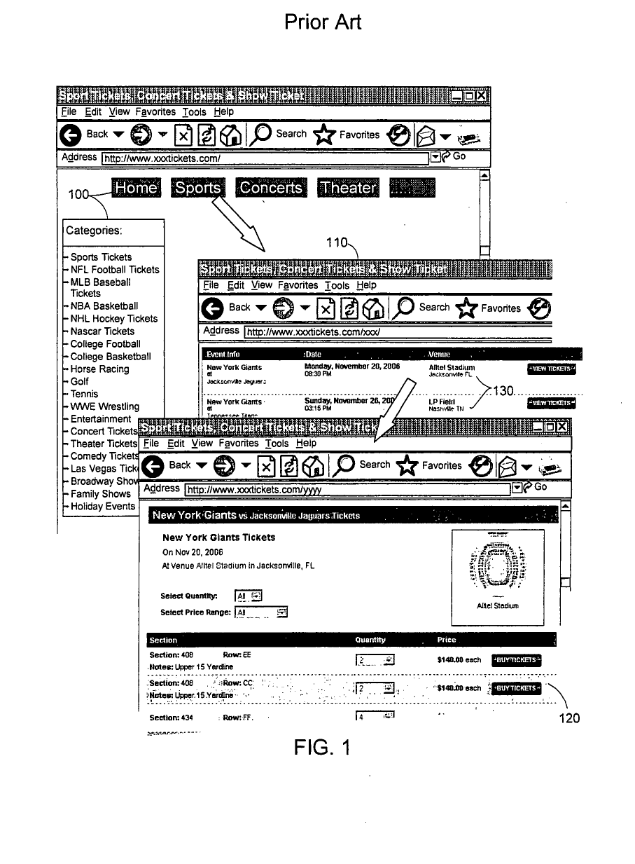

If end-user (250) is a football fan desiring to attend a game where his/her favorite team is a participant he/she will have to access one of the sites from where tickets can be obtained. This can be the football team home site itself, if providing such a service, as well as any of the service provider sites specialized in the selling of tickets. Whichever site is actually used, as discussed in FIG. 1, after having done the proper selections, end-user of such a traditional site is eventually proposed a series of events to attend (260). However, contrary to the prior art website of FIG. 1 end-user is not forced to select a particular event among the set of proposed events (260) to go further and obtain a ticket. With a website making use of the invention end-user is rather expected to enter at least a home location (270) after which a trip evaluation can be requested (280) for the set of events proposed i.e., for the various dates and away locations listed (260).

Depending on the application of the invention and web design choices further options have optionally to be entered by the end-user prior to requesting trip evaluations to be performed by the website server engine. For example, the end-user may be offered the option of minimizing the overall time to spend in order to attend an event or the option of minimizing the expenses. Also the end-user may want to exclude some modes of transportation. These options are selected, for example, through standard combo-boxes as shown (272, 274). Hence, the invention does not assume a mandatory list of options. Depending on web client design choices, and the type of application considered, fewer or more options to choose from may be offered to the end-user.

Then, as soon as end-user has clicked the trip evaluation button (280) all events dates and locations listed (260) are submitted to the website server engine (200) along with the end-user entered parameters discussed above including the home location (270) and other optional parameters like, for example, preferences of not having to drive more than 100 miles or more than one hour.

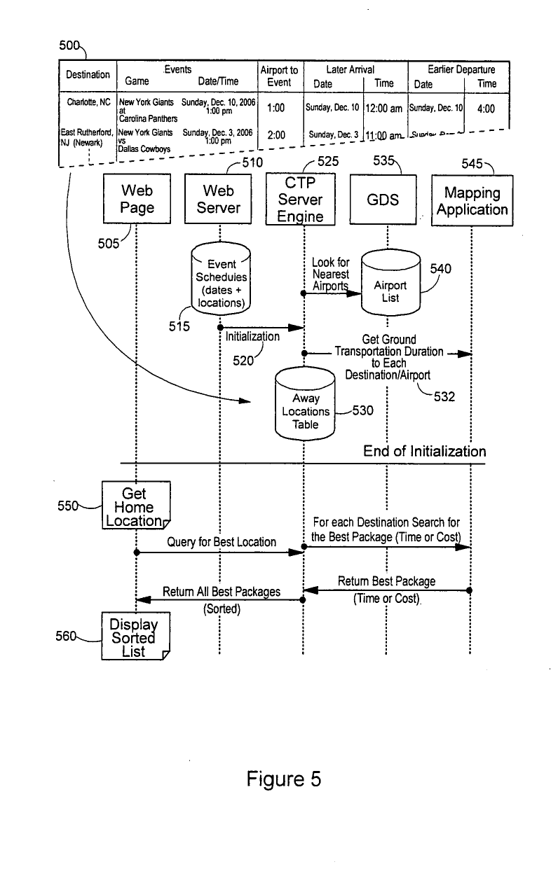

Choices exercised by the end-user of a client web site (265) must however be prepared through an initialization phase taking place between a web server of the invention (200), providing the comprehensive travel packages, and the client web sites accessed by the end-users. This aspect of the invention is further discussed in FIG. 5.

In an alternate implementation of the invention the displayed events, resulting of the choices previously performed by the end-user on what he/she desires to attend, can be optionally individually deselected (290), prior to requesting trip evaluations, so that it is possible to manually exclude one or several of the proposed events if end-user considers some of them do not fit anyway his/her preferences. In the example of FIG. 2, the last before one of the proposed event has been deselected (292) by the end-user who does not want to attend a football game on the eve of Christmas day.

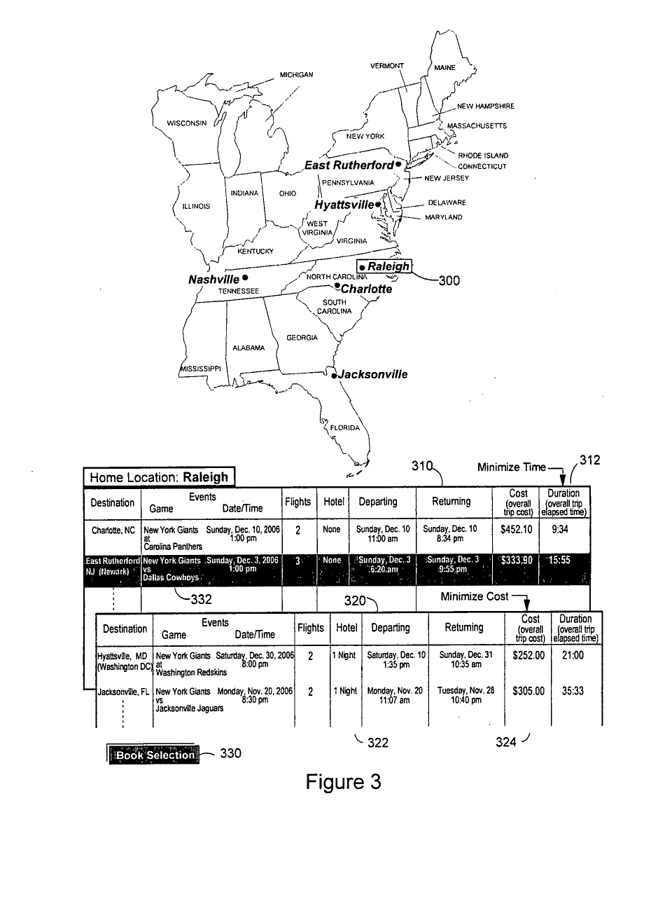

FIG. 3 shows, through an example, what is returned to the end-user of a website making use of the server engine of the invention (200) to the end-user who has requested to attend any of the selected events at away locations shown in FIG. 2 (260). The tables (310, 320) of FIG. 3 assume that home location chosen by end-user is Raleigh, N.C. (300).

If the end-user has chosen, for example, to minimize time to attend one of the events, table (310) is returned. The shortest trip from home is indeed first picked by the website server engine since it finds, consulting the databases and sites previously mentioned, it is actually feasible to attend the corresponding event within an elapsed time of 9 hours and 34 minutes (312), flying to and from Charlotte, N.C., the same day, at very convenient times. This choice appears to be the most expensive though since airline fares have often little to do with the actual flying distance. Table (310) assumes that end-user has also chosen not to drive long distances so that the option of driving from Raleigh to Charlotte (155 miles away) has not been considered. The choices of minimizing the overall trip elapsed time and of excluding some mode of transportation, like excluding driving long distances, have been performed as explained in FIG. 2 before submitting the request to the website server engine.

The second choice returned in table (310) shows that a round trip to New Jersey (Newark airport), although it is a much more distant location, can also be done on the same day (Sunday, December 3) to attend a game in East Rutherford. However, at far less convenient times since it is necessary to leave very early in the morning. The overall elapsed time is thus also higher (15:35) with a better cost though. The other travel options, not shown, corresponding to the remaining selected events (260) of FIG. 2, require more time and may even be also more expensive, like traveling to Nashville, Tenn., because no direct flight exists between the two towns on that day. Thus, in table (310), events are listed in increasing order of their trip elapsed time (312) so that end-user can exercise a choice knowing all consequences in terms of time and cost.

If, contrary to what has been assumed above, end-user has chosen to minimize the travel expenses, table (320) is returned instead. In which case, the less expensive found option is listed first. In this example, it corresponds to flying to Washington, D.C. on Saturday, December 30 because the location of the corresponding event is in Hyattsville, Md., located just outside of the District of Columbia. Because event is taken place at night (8:00 pm), a one-night stay (322) in a nearby hotel is included too. In spite of this, a much better deal is obtained however at the expense of a higher elapsed time of 21 hours. In a similar manner, all the selected events (260) of FIG. 2 are listed in cost increasing order (324). As a second choice the end-user is then proposed to fly to Jacksonville, Fla., in which case the cost is not only slightly higher but the overall elapsed time of the trip is much increased too.

From the travel options that are displayed end-user is expected to eventually exercise a choice and pick a travel package. In the example of FIG. 3 this is done by highlighting one of the proposed options (332) after which the book selection button (330) is clicked to trigger the actual booking.

For the sake of clarity, the above description of the invention done through examples, has only considered airline flying times and ticket costs and overnight stays and hotel costs for estimating overall travel expenses and trip durations. Depending on the level of sophistication and available computing resources of the website server engine (200) shown in FIG. 2, it will be apparent to those skilled in the art that home to home trip times and expenses will preferably also include further contributors. In the examples chosen above to illustrate the invention, the estimations of the expenses could also include what must be spent to reach, from airports, the stadiums where football games are played. Same remark applies when overnight stays have been scheduled. Transportation expenses between stadiums and airports such as taxi or car rental bills should be considered too. Also, home location to home airport must be taken into consideration since, generally, large town airports are very far from city centers and their contribution could become significant. Moreover, specified home location may be such that a choice between several airports to leave from and return to must be also considered to propose a best travel package. For example, this is the case if home location is a town having no airport and if several of the closest airports are equally susceptible to be used. This aspect of the invention is also further discussed in FIG. 6. Deciding of taking into consideration the above extra parameters, and possibly others, can be optionally selectable in the end-user interface of FIG. 2. Like the entered home location (270), they will then serve as inputs to the website server engine (200) to perform trip estimations when requested to do so. As already discussed, this latter is assumed to have access to specialized sites, such as the map application site shown (230), and all sorts of internal or external databases in order to also estimate the contribution of ground transportation to the overall expenses and travel time durations.

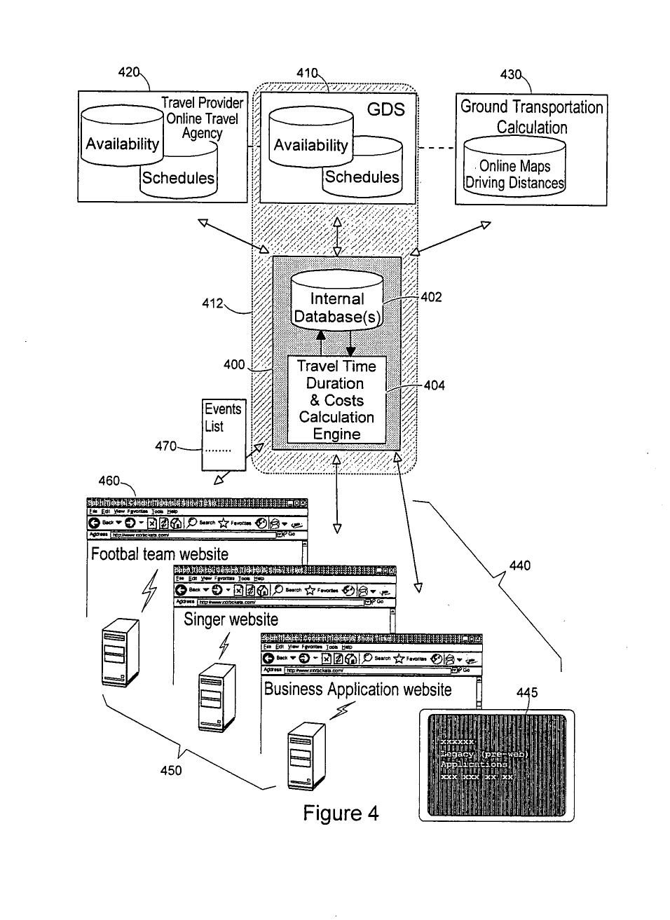

FIG. 4 shows a website server engine (400) according to the invention in its environment.

Server engine includes one or several internal databases (402) aimed at gathering all sorts of travel information from the various online sources previously discussed; namely: GDS (410), service travel providers such as the online travel agencies or the websites of airline or car rental companies (420), websites specialized in the calculation of ground transportation itineraries and driving distances and times (430), and so on.

Server engine (400) also includes a cost and travel time duration calculation engine (404) to estimate the overall trip elapsed time and costs, from home to home, to attend an event. To this end, it uses the information gathered in the internal database(s) (402) and can also issue specific queries to the online sources of travel to find any information needed to complete the calculation of a trip elapsed time and determine costs. Server engine further includes any kind of tools to optimize calculations so as to provide a reliable service to the web client applications.

Website server engine (400) can thus be used simultaneously by numerous end-users of all sorts of client web applications (440) running from their own computerized resources (450). This can be, for example, the website of a football team (460) holding the schedules and dates of the games to which team is participating and from where they can be displayed on the browser of site end-users. The invention thus assumes that the corresponding table of events (i.e., the set of games to which team participates in a season or during a defined period possibly selected by the end-users) can be transmitted (470) to the server engine (400) so that a comprehensive set of travel packages, best suited to attend the submitted events, can be calculated and returned to the end-users of the football team website as discussed in FIG. 3.

Server engine (400) can serve as well legacy software applications (445) especially those that would be still used e.g., by large travel organizations or travel agencies running pre-web applications from mainframes.

Also, in an alternate implementation of the invention, the website server engine (400) is just part of the services offered by a GDS (412) so that the specialized websites (450) or the legacy applications (445) can address GDS directly to get the corresponding services.

FIG. 5 shows the steps of the method of the invention.

Prior to the handling of the end-user requests submitted through a web page (505) displayed by a client web server (510) of a CTP provider engine according to the invention (525) an initialization phase (520) may optionally have been completed first. This optional step, that allows expediting the processing of end-user requests, includes the submission by the web server (510) of the database of events to be considered (515), i.e., all events that are possibly proposed to the end-users of a particular web server application. In the previous example of FIG. 2, illustrated with a football site, this represents, for example, the set of football games to be considered during a season and that are offered to selling by the owner of the web site.

Alternatively, the away locations table (530), shown to be held by CTP provider (525) in FIG. 5, can be as well housed by web server itself (510).

On the basis of the locations and dates of the submitted events, CTP provider engine (525) can thus determined a list of airports to be considered (540). As discussed previously, this is achieved by consulting all necessary specialized web sites, and notably a GDS (535). Tables of away locations (500) corresponding to the submitted list of events can thus be established and held in a database (530) to later handle all the end-user requests. Tables include the events to be considered (dates and locations) along with the time necessary to reach event locations from the selected airports through ground transportation means. To this end, all necessary specialized web sites need to be consulted (532) too. Typically, this includes the mapping application sites previously mentioned in order to get driving distances.

After the initialization has completed web server is then able to handle end-user requests. On the basis of event lists displayed by the web server application in web page, such as the one (260) in example of FIG. 2, end-user enters a home location (550) and, optionally, other preferences as previously discussed. This triggers, on the basis of the specified home location, the query for the best event locations and the search of the corresponding travel packages that minimize time or cost depending on what end-user has selected.

The best travel packages are then returned and sorted before being displayed to the end-user (560), as shown in example of FIG. 3, so that he/she can select a travel option (332) and perform the corresponding booking (330).

Although the invention has been mainly illustrated, up to this point, through the selection of a sport event it must be clear that it is not limited to this particular example and that its field of applications is wider and much more general.

For example, in the recent years there has been an exponential growth in the number of sites enabling socializing networks, i.e., sites where people with common interests get in contact through the Internet. Some of these websites provide to their users/subscribers search tools enabling them to restrict their contacts to people possessing certain characteristics by specifying the appropriate search criteria. While, for some of these websites, socializing intends to remain a pure virtual activity (i.e., destined to happen exclusively on the net) others enable actual socialization (e.g., dating sites) hence, introducing a distinction between socializing between persons and socializing around a place or subject of common interest (e.g., websites providing information about events, historical sites, etc.). When real socializing (i.e., getting together) is considered, a website usually also provides means to restrict the search on the basis of geographic criteria. A criterion is then typically the country/state/region where people live while another one is the mileage distance to meet them. In which case such a site can better take advantage of the invention to focus the search on the user and to permit that results be ordered or ranked according to the used criteria. Like in FIG. 2, requests are done in the form of a home location, a list of allowed means of transport and a list of away locations. Events are, in this application of the invention, people to meet possibly associated to a date as shown in the example table hereafter:

Home location: New-York, NY

| Away locations | Dates |
|---|---|
| Patricia lives in Raleigh, NC | Available Wednesday Sept. 19 at 8:00 pm |
| Valerie lives in Washington, | Available Sunday Sept. 30 at 4:00 pm |
| DC | |

If the date column is provided, as with the previous football example in FIG. 2, a system according the invention takes into account the arrival date and time to calculate the overall travel time durations and costs.

Also, in the case of socializing websites, the cost or times metrics used by the invention to determine a better location to attend an event can be used for a priori filtering of the people to meet from a specified home location so that only those that can possibly be met in a given span of time or distance or for a travel cost not exceeding a preset value, are indeed only considered and proposed to the end-user of the website. Thus, in this application of the invention, the above table may not include any meeting date and is rather used first to filter the people to meet. Hence, the end-user of the socializing website can be certain he/she offered to meet only people that match with his/her preferences. Preferences are set by the end-user himself/herself e.g., in a profile when registration to the socializing website is done. While the actual meeting dates are not yet known filtering is carried out on the basis of minimum, average and maximum values for the chosen metric; e.g., the maximum time or maximum cost to spend to meet people. When actual meeting dates are known the invention can then proceed as described in previous figures considering people to meet, in various locations and dates, as series of events according to the definition used by the invention.

The different databases necessary to compute costs and travel time durations between the home location and all the different away locations are queried as also depicted in FIG. 2. Each travel time duration is generally composed of one ore more travel segments, and the method stores the list of the different travel segments together with the corresponding means of transportation and travel times. These travel time durations are based on schedules and actual availability when applicable.

Then, the system would return, as a default display option, the list of away locations in order of increasing travel times or increasing costs, examples of which are shown in FIG. 3. A more sophisticated display of the results would include graphics, e.g., plotting:
Along the X axis: travel times through the main means of transportation;
Along the Y axis: residual travel times;
A different symbol (or color) for the different means of transportation (e.g.: a cross if traveling by train, a circle if traveling by plane);
A label with the name of the away location;

Other applications of the invention are in the field of business applications; especially for meetings management. The invention is indeed able to manage complex situations as sketched in FIG. 6 through the particular example of a business people having to attend a meeting in a place different from his/her home location. Hence, in a similar manner as previously discussed, inputs are provided by the end-user of a specialized professional web server (610), i.e., the business people his/herself or any one acting on his/her behalf such as a secretary or a travel agency agent. Professional web server is here, for example, a corporate application used by the employees of a large company to organize their meetings, a travel organization business application or any specialized site offering this service to its registered users.

Inputs (650) consists in this example, as previously, of the home (or business) location and also includes the meeting place and meeting schedule preferably under the form of an input table, as shown (620), in which meeting must take place in city M from 2:00 to 5:00 pm. This example used to illustrate the professional application of the invention specifically assumes that the meeting place is in a city with no large airport, or no airport at all, so that the CTP provider engine (625) is bound to consider also the closest surrounding airports (640) to determine the best travel solutions to attend the meeting. Hence, if to reach the city where meeting takes place (621) there are very few or no possible flights from the home location, other surrounding important airports i.e.: cities A1, A2 and A3 (622) in this example, are included in the away locations table previously described (630) so that CTP provider engine can thoroughly review all associated constraints and advantages, including: driving distances, frequency of connections to other important airports, schedule of flights that would avoid to stay overnight to attend meeting or to depart too early from the home location. In a similar manner as with previously described application of the invention, a sorted list of options is eventually provided to the end-user (660) after the relevant specialized web sites and GDS have been consulted (635, 645). From the sorted list of options a selection can be performed and trip booking done thus greatly simplifying the task of a business people to find, from a home or business location, the shortest or cheapest possible trip to attend a meeting.

In this application of the invention it is worth noting here that, contrary to what is shown in FIG. 5, no optional initialization step can possibly be carried out since meeting in this case is a one-time event, set by a professional, not part of a published series of events as e.g., the sport events used to illustrate the invention in previous figures.

Finally, the above process can be applied as well to a group of people. Being given a list of N people from L different locations and a list of P events in which they are interested (i.e., a list of destination/time couples), the invention can select the best single event that should be attended by the whole group to minimize one of the following metrics:
the group total cost
the total time spent by all group members
any combination of both above metrics
with or without allowed values set; e.g.: requesting that no more than 1000$ be spent per each group member.

1. A system for providing a set of comprehensive travel packages to attend an event out of a series of scheduled events, the system comprising:
a server engine (400) further comprising:
means for gathering all sorts of online travel related information from a plurality of specialized websites (410, 420, 430);
means for storing the gathered travel information (402);
means for calculating overall travel time durations and costs (404) in order to dynamically build the set of comprehensive travel packages from the gathered travel information and on the basis of a home location (300);
means for delivering to a plurality of client websites (440) the sets of comprehensive travel packages (310, 320) in response to the submission by end-users of the client websites of queries to attend events out of series of scheduled events (470), each said query including the home location (270) to be used for dynamically building the corresponding set of comprehensive travel packages;
thereby, selecting event with the most appropriate date and location allowing to deliver the best travel package for the specified end-user home location.

2. The system of claim 1 wherein the end-user queries include further end-user preferences.

3. The system of claim 2 wherein the further preferences include minimizing overall trip elapsed times (312).

4. The system of claim 2 wherein the further preferences include minimizing overall trip costs (324).

5. The system of claim 2 wherein the further preferences include excluding some transportation means (272).

6. The system of claim 2 wherein the further preferences include excluding driving beyond a specified distance or more than a specified time.

7. The system of claim 1 wherein the means for delivering includes delivering the sets of comprehensive travel packages to legacy applications (445).

8. The system of claim 7 wherein the means for gathering travel related information operates on the basis of events lists (470) supplied by the plurality of client websites (440) or legacy applications (445) prior to the handling by the server engine of queries issued by end-users of the client websites or of the legacy applications.

9. The system of claim 7 wherein the means for calculating overall travel time durations and costs further includes determining a list of one or more nearest airports (540) on the basis of the event locations supplied in the events lists.

10. The system of claim 9 wherein the server engine (400) further builds tables of away locations (530) including ground transportation times to/from the determined one or more nearest airports (500) to/from the event locations.

11. The system of claim 9 wherein the tables of away locations are optionally held in the web server (510).

12. The system of claim 1 wherein the end-users (250) of the client applications (440) may optionally deselect any one(s) (292) of the proposed series of events (260) prior to requesting (280) from the server engine (400) the dynamic building of the set of comprehensive travel packages corresponding to the remaining selected series of events (290) on the basis of the home location (270) and of the other optional preferences (272, 274).

13. The system of claim 12 wherein the server engine returns the dynamic built set of comprehensive travel packages (310, 320) including a means for booking (330) any one of the offered travel packages when properly selected (332) by the end-user of the client application.

14. The system of claim 12 wherein the building of the set of comprehensive travel packages includes determining a list of one or more nearest airports on the basis of the home location supplied with the request (280).

15. The system of claim 9 wherein the building of the set of comprehensive travel packages further includes taking into consideration the expected road traffic conditions or forecasted weather.

16. The system of claim 12 wherein the returned set of comprehensive travel packages includes the time and cost impacts of overnight stays necessary to attend events.

17. The system of claims 9 wherein the returned set of comprehensive travel packages includes the time and cost impacts of ground transportation to/from event location from/to the nearest event airport(s), and to/from home from/to the nearest home airport(s).

18. The system of claim 12 including in client applications a graphic user interface (GUI) to allow end-users of the client websites (440) to issue queries for getting comprehensive travel packages to attend an event out of a series of events (260) offered by the client websites, comprising:
a graphic means to enter home locations (270),
a graphic means to enter further preferences (272, 274),
a graphic means to submit the queries (280).

19. The system of claim 1 wherein the series of events is replaced by a list of selected people to meet in away locations and wherein people selection is carried out on the basis of a cost or time metric to restrict selection to only those of the people fitting in the cost or time metric.

20. The system of claim 19 wherein the returned set of comprehensive travel packages (310, 320) is replaced by an evaluation of the minimum, average and maximum times and costs to meet the people of the selected list.

21. The system of claim 18 wherein the list of people is comprised of only one people who can possibly be met in a plurality of locations, times and dates.

22. The system of claim 1 wherein the series of events is replaced by a scheduled meeting (650) to be attended by an individual and wherein meeting is held away from his/her home location.

23. The system of claim 22 wherein the away location table (630) includes a comprehensive list of airports, arrival and departure times to choose from in order to attend the scheduled meeting.

24. The system of claim 1 wherein the query to attend an event out of a series of scheduled events is issued for a group of people coming from a plurality of home locations to attend the same event and wherein further preferences include: minimizing the group total cost; minimizing the group total spent time; or minimizing any combination of time and cost.

25. The system of claim 24 wherein a time or spending limit is set per group member.

26. The system of claim 1 wherein the comprehensive travel package server engine is a service part of a GDS (412) service offering.

27. A method in a server engine (525) for providing a set of comprehensive travel packages to attend an event out of a series of scheduled events, comprising:
optionally, during an initialization phase, prior to receiving queries from end-users of client websites (440),
receiving (520) from the client websites events lists comprising locations, dates and times of scheduled events (515);
gathering (532), on the basis of the events lists, travel related information from a plurality of specialized websites (545); the gathering step including the determination of the nearest event airports (540);
creating (530) tables of away locations (500) corresponding to the events lists and including event airport access times;
after initialization phase is complete,
processing queries issued by the end-users of the client websites to attend series of scheduled events; said queries including a home location (550) and, optionally, other preferences;
searching for and building comprehensive travel packages for the queried series of scheduled events and adapted for the home locations and other provided preferences;
returning to the end users of the client websites (560) sets of comprehensive travel packages; said returning step including the further step of sorting the comprehensive travel packages according to the provided preferences or to a default sorting method.

28. A method for the end-user of a client web site to attend an event out of a series of scheduled events, comprising:
from the client website,
selecting a preferred series of events (260); said selecting step including the optional step of deselecting (292) specific events out of the series of scheduled events;
entering a home location (270) and, optionally, other preferences (272, 274);
requesting trips evaluation (280) for the selected series of events on the basis of the home location and other preferences;
after a set of comprehensive travel packages is returned to the client website,
selecting an option (332) out of the returned set of sorted comprehensive travel package (310);
requesting booking (330) of the selected travel option.

29. The method according to claim 27 wherein events consist of people to meet in away locations.
